(19) United States
(12) Patent Application Publication
(10) Pub. No.: US 2008/0012819 A1
(43) Pub. Date: Jan. 17, 2008

(54) DISPLAY DEVICE AND METHOD OF DRIVING THEREOF

(75) Inventors: Chul Hwan Lee, Suwon-si (KR); Ahn Ho Jee, Hwaseong-Si (KR); Dong Hwan Lee, Yongin-Si (KR); Jin Young Choi, Seoul (KR); Yong Han Park, Anyang-Si (KR); Tae Kyung Lee, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/690,687

(22) Filed: Mar. 23, 2007

(30) Foreign Application Priority Data
Jul. 12, 2006 (KR) 10-2006-0065484

(51) Int. Cl. G09G 3/36

(52) U.S. Cl. 345/100

(57) ABSTRACT

A gate driving unit connected to odd-numbered gate lines and a gate driving unit connected to even-numbered gate lines are sequentially operated, and a common voltage signal is inverted when the operation states of the two gate driving units are changed, thereby minimizing a number of changes in the voltage level of the common voltage signal supplied to a display panel during one frame, reducing power consumption of the display device, and allowing pixels of the display panel to perform line inversion.

This application claims priority to Korean Patent application No. 10-2006-0065484, filed on Jul. 12, 2006, and all the benefits accruing therefrom under 35 U.S.C. § 119, the contents of which in its entirety are herein incorporated by reference.

### BACKGROUND OF THE INVENTION

1. Field of Invention

The present invention relates to a display device and a method of driving a display device, and more particularly, to a method of driving a display device, wherein power consumption can be reduced and audible noise can also be reduced or effectively eliminated.

2. Description of the Prior Art

A liquid crystal display (“LCD”) device, which is one example of a flat display device, displays images by changing an electric field between a pixel electrode and a common electrode of a liquid crystal panel to adjust optical transmittance of liquid crystals provided between the electrodes. To change the electric field between the two electrodes, a data voltage including gradation information, also known as gray scale information, is applied to the pixel electrode and a common voltage is applied to the common electrode. An LCD display device is typically made of a plurality of pixels arranged in a matrix pattern, wherein the magnitude of the voltage applied to the pixel electrode may be varied individually from pixel to pixel.

Modern LCD devices exhibit more uniform image quality and have a longer display life-time, by preventing deterioration of liquid crystals through inversion driving. In older LCD devices, the electric field applied between the pixel electrode and the common electrode was applied in only one direction. This led to a rapid deterioration and polarization of the liquid crystal molecules. This deterioration may be substantially reduced or effectively prevented by occasionally inverting the polarity of the applied electric field.

Particularly, in small- or medium-sized liquid crystal display devices, line inversion, also known as row inversion, driving is performed. Line inversion driving involves inverting the polarity of voltages applied to the pixels of an LCD on a row by row basis. Unfortunately, it is very difficult to exactly match the inverted and non-inverted voltages around a constant common voltage. Therefore, the common voltage is varied to compensate for discrepancies in the voltage inversion.

To perform the line inversion driving, a signal level of a common voltage applied to a common electrode should be changed according to a change in a signal on a turned-on gate line. Accordingly, in the small- and medium-sized liquid crystal display devices, a common voltage signal with a high frequency of 10 kHz to 12 kHz is generated and then applied to the common electrode. However, the use of the common voltage signal with a high frequency increases power consumption of the liquid crystal display device and causes audible noise. The high-frequency common voltage signal causes vibration of a substrate and thence audible noise.

### BRIEF SUMMARY OF THE INVENTION

An aspect of the present invention is to provide a method of driving a display device, wherein power consumption can be reduced and generation of audible noise can be prevented by sequentially operating a plurality of gate driving units and changing the voltage level of a common voltage signal whenever each of the gate driving units is operated so as to lower the frequency of the common voltage signal.

According to an exemplary embodiment of the present invention, a method of driving a display device includes; a first step wherein gate voltage signals are sequentially supplied to a first group of gate lines; and a second step wherein gate voltage signals are sequentially supplied to a second group of gate lines which differ from the first group of gate lines, wherein a common voltage signal in the first step and a common voltage signal in the second step have different logic voltage levels, respectively.

In one exemplary embodiment a data voltage signal and the common voltage signal have different logic voltage levels, respectively.

In one exemplary embodiment the gate lines in the first group of gate lines may be odd-numbered gate lines, and the gate lines in the second group of gate lines may be even-numbered gate lines.

In one exemplary embodiment, a first gate driving unit is provided in one area of the display device to supply the gate voltage signals to the first group of gate lines, and a second gate driving unit is provided in another area of the display device to supply the gate voltage signals to the second group of gate lines.

According to another exemplary embodiment of the present invention, a method of driving a display device includes the steps of; dividing a plurality of gate lines into a plurality of groups of gate lines, wherein each of the groups of gate lines is one of an odd numbered group of gate lines and an even numbered group of gate lines, and each of the groups of gate lines includes at least two gate lines, and sequentially driving the groups of gate lines in a predetermined order during one frame, wherein a common voltage signal with a first logic voltage level is applied when an odd numbered group of gate liens is driven, and a common voltage signal with a second logic voltage level is applied when an even numbered group of gate lines is driven.

In one exemplary embodiment a data voltage signal and the common voltage signal preferably have different logic voltage levels, respectfully.

According to another exemplary embodiment of the present invention, a display device includes; a first group of gate lines, and a second group of gate lines, wherein a gate voltage is sequentially supplied to the gate lines in the first group of gate lines and then supplied to the gate lines in the second group of gate lines and wherein a common voltage signal with a first logic voltage level is applied when the first group of gate liens is driven and a common voltage signal with a second logic voltage level is applied when the second group of gate lines is driven.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a block diagram of a first exemplary embodiment of a liquid crystal display (“LCD”) device according to the present invention;

FIG. 2 is an equivalent circuit diagram illustrating an exemplary embodiment of one pixel of the first exemplary embodiment of an LCD device according to the present invention;

FIG. 3 is a signal waveform diagram, illustrating the operation of the first exemplary embodiment of an LCD device;

FIG. 4 is a diagram illustrating polarities upon line inversion driving of the first exemplary embodiment of an LCD device;

FIG. 5 is a block diagram illustrating first exemplary embodiment of a liquid crystal panel and an exemplary embodiment of a gate driving unit;

FIG. 6 is a waveform diagram illustrating the operation of the first exemplary embodiment of an LCD device;

FIG. 7 is a waveform diagram illustrating a variation on the operation of a first exemplary embodiment of an LCD device;

FIG. 8 is a block diagram illustrating a second exemplary embodiment of an LCD and a gate driving unit according to the present invention; and

FIG. 9 is a waveform diagram illustrating the operation of the second exemplary embodiment of an LCD device.

### DETAILED DESCRIPTION OF THE INVENTION

Hereinafter, exemplary embodiments of the present invention will be described in more detail with reference to the accompanying drawings. However, the present invention is not limited to the exemplary embodiments set forth herein but can be implemented in different forms. Rather, the exemplary embodiments are merely provided to allow the present invention to be completely described herein and to fully convey the scope of the present invention to those skilled in the art. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “below,” “lower”, “under,” “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning which is consistent with their meaning in the context of the relevant art and will not be interpreted in an idealized or overly formal sense unless expressly so defined herein.

Hereinafter, the present invention will be described in more detail with reference to the accompanying drawings.

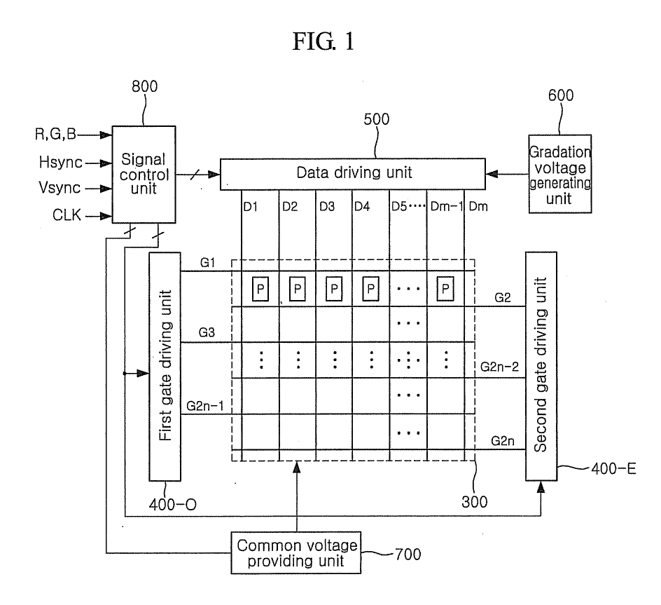

FIG. 1 is a block diagram of a first exemplary embodiment of a liquid crystal display (“LCD”) device according to the present invention.

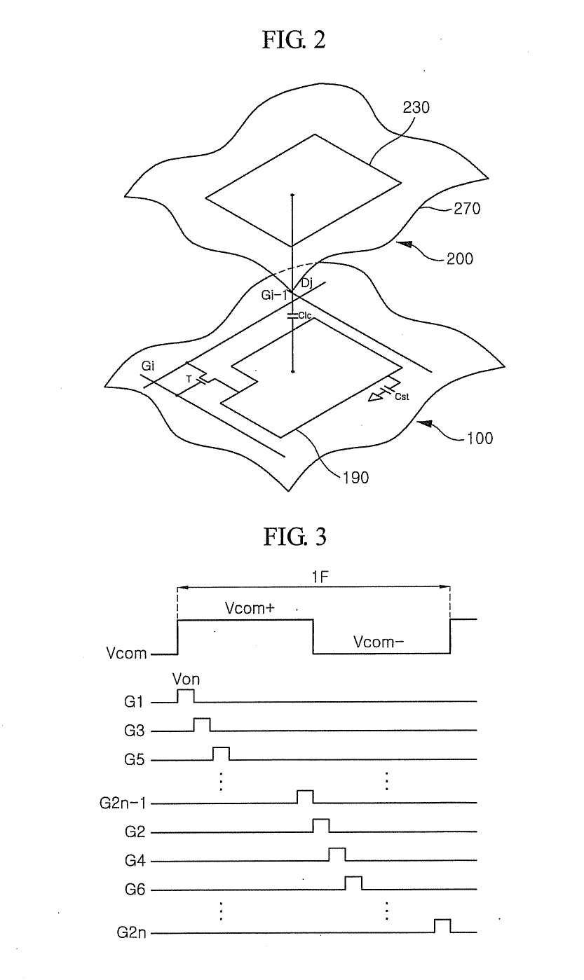

FIG. 2 is an equivalent circuit diagram illustrating an exemplary embodiment of one pixel of the first exemplary embodiment of an LCD device according to the present invention.

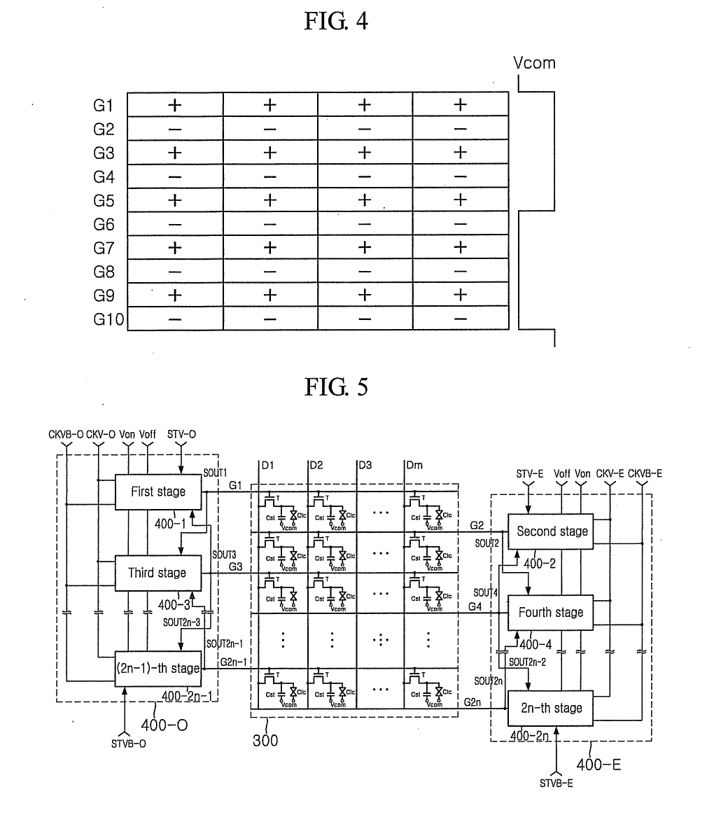

FIG. 3 is a signal waveform diagram, illustrating the operation of the first exemplary embodiment of an LCD device, and FIG. 4 is a diagram illustrating polarities upon line inversion driving of the first exemplary embodiment of an LCD device.

Referring to FIGS. 1 to 4, a first exemplary embodiment of an LCD device includes a liquid crystal panel 300 having a plurality of pixels P arranged in a matrix form, a plurality of gate driving units 400-O and 400-E (400) connected to the liquid crystal panel 300, a data driving unit 500 connected to the liquid crystal panel 300, a gradation voltage generating unit 600 connected to the data driving unit 500, a common voltage providing unit 700 connected to the liquid crystal panel 300, and a signal control unit 800 for controlling the operation of the respective units.

The liquid crystal panel 300 includes a plurality of gate lines G1 to G2n arranged in rows and a plurality of data lines D1 to Dm arranged in columns, wherein n and m are natural numbers, e.g., positive integers. The gate lines G1 to G2n extend in rows and the data lines D1 to Dm extend in columns. A pixel region is surrounded by corresponding gate lines G1 to G2n and the data lines D1 to Dm, and pixels P are provided in the pixel regions.

As shown in FIG. 2, each pixel P includes a liquid crystal capacitor C1c and a storage capacitor Cst. According to the present exemplary embodiment the liquid crystal capacitor C1c includes a pixel electrode 190 on a lower display plate 100 and a common electrode 270 on an upper display plate 200, as shown in FIG. 2. Liquid crystals (not shown) provided between the pixel electrode 190 and the common electrode 270 serve as dielectrics. The storage capacitor Cst is formed by superimposing the pixel electrode 190 and a separate storage electrode (not shown) provided on the lower display plate 100. Alternative exemplary embodiments include configurations wherein the storage capacitor Cst is formed of the pixel electrode 190 and an upper gate line which overlaps therewith in a state where an insulating material is disposed therebetween. In another exemplary embodiment the storage capacitor Cst may be eliminated. The pixel P further includes a switching device T for applying data line signals D1 to Dm to one terminal of each of the liquid crystal capacitor C1c and the storage capacitor Cst, e.g., the pixel electrode 190, in response to signals of the gate lines G1 to G2n. According to the current exemplary embodiment, a thin film transistor (“TFT”) is used as the switching device T. The common voltage signal Vcom is supplied to the common electrode 270 and/or the storage electrode.

Meanwhile, in the current exemplary embodiment each unit pixel P displays one of three primary colors R, G and B, otherwise known as spatial color combination. In an alternative exemplary embodiment the unit pixel P alternately display each of the three primary colors over a period of time, otherwise known as temporal color combination. A spatial or temporal combination of the three primary colors R, G, and B can be used to implement a target color. In the current exemplary embodiment, the spatial combination is used to implement a color. As shown in FIG. 2, the unit pixel P according to the current exemplary embodiment includes a color filter 230 for uniquely displaying one of the three primary colors R, G and B. Alternative exemplary embodiments include the configuration wherein the color filter 230 may be provided on the lower display plate 100, as well as on the upper display plate 200 as shown in FIG. 2. The color filter 230 displays one of red R, green G and blue B. In the current exemplary embodiment, the pixel P is called a red, green or blue pixel depending on the color displayed by the pixel P.

As shown in FIG. 1, the gate driving units 400-O and 400-E include the first gate driving unit 400-O provided at one side of the liquid crystal panel 300 and connected to odd-numbered gate lines G1 to G2n−1 of the plurality of gate lines G1 to G2n of the liquid crystal panel 300, and the second gate driving unit 400-E provided at the other side of the liquid crystal panel 300 and connected to even-numbered gate lines G2 to G2n. The first and second gate driving units 400-O and 400-E apply a gate turn-on voltage signal Von and a gate turn-off voltage signal Voff to the gate lines G1 to G2n connected thereto. According to the current exemplary embodiment, the gate turn-on voltage signal Von is applied to one gate line for one horizontal clock period 1H. According to the current exemplary embodiment the first gate driving unit 400-O and the second gate driving unit 400-E operate sequentially. First, the first gate driving unit 400-O sequentially applies the gate turn-on voltage signal Von to the odd-numbered gate lines G1 to G2n−1 to turn on a plurality of thin film transistors connected to the odd-numbered gate lines G1 to G2n−1. Then, the second gate driving unit 400-E sequentially applies the gate turn-on voltage signal Von to the even-numbered gate lines G2 to G2n to turn on a plurality of thin film transistors connected to the even-numbered gate lines G2 to G2n. As a result, all thin film transistors in the liquid crystal panel 300 are turned on to display an image. In this manner the first gate driving unit 400-O may be connected to at least a half of all the gate lines G1 to G2n and the second gate driving unit 400-E may be connected to the other half. To obtain a line inversion effect, the gate lines connected to the first and second gate driving units 400-O and 400-E may be sequentially arranged. One line may be connected to the first gate driving unit 400-O and the next line may be connected to the second gate driving unit 400-E, as described above and shown in FIG. 1.

The gradation voltage generating unit 600 generates a plurality of gradation voltage signals, e.g., the data voltage signals related to the luminance of the liquid crystal display device. Preferably, one of two groups has a positive value relative to the common voltage signal Vcom while the other group has a negative value. Thus, the two groups of voltage signals are inverted with respect to the common voltage signal Vcom.

The data driving unit 500 is connected to a plurality of data lines D1 to Dm of the liquid crystal panel 300 for applying the gradation voltage signal, e.g., a data signal, to the data lines D1 to Dm.

The common voltage providing unit 700 applies the common voltage signal Vcom at least to the common electrode 270 of the liquid crystal panel 300, in which the common voltage signal Vcom has a voltage level which varies whenever the operation of the respective gate driving units 400-O and 400-E is changed. The common voltage providing unit 700 applies the common voltage signal at a first voltage level to the liquid crystal panel 300 when the first gate driving unit 400-O operates, and applies the common voltage signal at a second voltage level to the liquid crystal panel 300 when the second gate driving unit 400-E operates. In this manner, the voltage level of the common voltage signal Vcom is changed once during one frame, e.g., the common voltage is applied twice per frame.

In a conventional technique, the voltage level of the common voltage signal Vcom is changed according to a change in the gate signal applied to the gate lines G1 to G2n, in order to perform the line inversion. For example, the common voltage signal at a first voltage level is supplied when the gate signal (e.g., gate turn-on voltage signal) is applied to the first gate line G1, and the common voltage signal at a second voltage level is applied when the gate signal is applied to the second gate line G2. The common voltage signal at the first voltage level is applied when the gate signal is applied to the third gate line G3, and the common voltage signal at the second voltage level is applied when the gate signal is applied to the fourth gate line G4, and so on until a gate signal has been applied to all of the gate lines. In this manner, in the conventional technique, the voltage level of the common voltage signal Vcom had to be changed many tens, hundreds, or thousands of times per frame depending on the size of the display. The conventional technique resulted in a problem in that the frequency at which the common voltage signal is applied is greatly increased. According to the current exemplary embodiment, however, the voltage level of the common voltage signal Vcom is changed only once during one frame, thereby greatly reducing the frequency of the common voltage signal Vcom, as described above.

The signal control unit 800 receives external control signals including image signals R, G and B, frame division signals such as a vertical sync signal Vsync and a horizontal sync signal Hsync, and a main clock signal CLK, and generates and outputs control signals to control the operation of the first and second gate driving units 400-O and 400-E, the data driving unit 500, the gradation voltage generating unit 600, and the common voltage providing unit 700.

The operation of the liquid crystal display device according to the first exemplary embodiment will be described below.

The signal control unit 800 receives external control signals, processes the image signals R, G and B, generates control signals including a gate control signal and a data control signal, and transmits them to respective units.

In response to the gate control signal, the first gate driving unit 400-O is operated first and sequentially supplies the gate turn-on voltage signal Von to the odd-numbered gate lines G1 to G2n−1 of the liquid crystal panel 300 connected to the first gate driving unit 400-O as shown in FIG. 3. In this manner, a thin film transistor connected to each of the odd-numbered gate lines G1 to G2n−1 is turned on. In the current exemplary embodiment, as shown in FIG. 4, when the gate turn-on voltage signal Von is sequentially supplied to the odd-numbered gate lines G1 to G2n−1, the common voltage providing unit 700 supplies the common voltage signal Vcom+ at a first voltage level to the common electrode 270 of the liquid crystal panel 300. Next, in response to the gate control signal, the second gate driving unit 400-E is operated and sequentially supplies the gate turn-on voltage signal Von to the even-numbered gate lines G2 to G2n connected to the second gate driving unit 400-E as shown in FIG. 3. In this manner, a thin film transistor connected to each of the even-numbered gate lines G2 to G2n is turned on. In the current exemplary embodiment, as shown in FIG. 4, when the gate turn-on voltage signal Von is sequentially supplied to the even-numbered gate lines G2 to G2n, the common voltage signal Vcom− at a second level is supplied to the common electrode 270 of the liquid crystal panel 300. Meanwhile, the data driving unit 500 driven in response to the data control signal supplies the data voltage signal to the pixel electrode 190 of the liquid crystal panel 300 via the turned-on thin film transistor.

In this manner, the gate turn-on voltage signal Von is supplied to all the gate lines G1 to G2n of the liquid crystal panel 300 during one frame 1F, thereby turning on the thin film transistors connected thereto. This allows the data voltage signal to be supplied to the pixel electrode 190 of the liquid crystal capacitor C1c in each pixel P. Further, when the data voltage signal is being supplied to the pixel electrode 190, the common voltage signal Vcom is supplied to the common electrode 270. In the current exemplary embodiment, since the voltage level of the common voltage signal Vcom is changed only once during one frame as described above, the number of changes in the voltage level of the common voltage signal Vcom can be reduced, resulting in reduction in power consumption of the device. The swing number of the common voltage signal (i.e., the number of changes in the signal) decreases, resulting in reduction in power consumption. In addition, the frequency of the common voltage signal Vcom and thence audible noise generated by the liquid crystal panel 300 can be reduced or effectively prevented.

The common voltage providing unit 700, which supplies the common voltage signal Vcom to the liquid crystal panel 300, performs an operation similar to frame inversion driving, and the liquid crystal panel 300 performs line inversion driving. As shown in FIG. 3, the common voltage signal Vcom+ at the first voltage level is supplied to the liquid crystal panel 300 when the odd-numbered gate lines G1 to G2n−1 are being sequentially driven, whereas the common voltage signal Vcom− at the second voltage level is supplied to the liquid crystal panel 300 when the even-numbered gate lines G2 to G2n are being sequentially driven. This can reduce power consumption as compared with a conventional technique in which the common voltage signals Vcom+ and Vcom− at the first and second voltage levels are alternately supplied to the liquid crystal panel 300 when the gate lines G1 to G2n are sequentially driven. In this exemplary embodiment, the pixels P connected to the gate lines G1 to G2n in the liquid crystal panel 300 sequentially have a positive signal polarity (+) and a negative signal polarity (−), so that the same effects as line inversion driving are obtained. As shown in a diagram illustrating polarities of FIG. 4, the positive signal (+) is charged in the respective pixels P connected to the first, third, fifth, seventh and ninth gate lines G1, G3, G5, G7 and G9, and the negative signal (−) is charged in the respective pixels P connected to the second, fourth, sixth, eighth and tenth gate lines G2, G4, G6, G8 and G10. Here, the signal polarity refers to the polarity of the data voltage signal relative to the common voltage signal Vcom. Although in this exemplary embodiment the voltage level of the common voltage signal Vcom has been described as being changed once during one frame alternative exemplary embodiments include configurations wherein the voltage level may be changed twice or more during one frame. In another exemplary embodiment, the voltage level of the common voltage signal Vcom is changed once for every additional set of gate lines after the first set, e.g., Vcom is changed once when the gate lines are divided into two groups, Vcom is changed twice when the gate lines are divided into three groups, Vcom is changed three times when the gate lines are divided into four groups, etc.

The operation of the first exemplary embodiment of an LCD device will be described in detail with reference to the accompanying drawings.

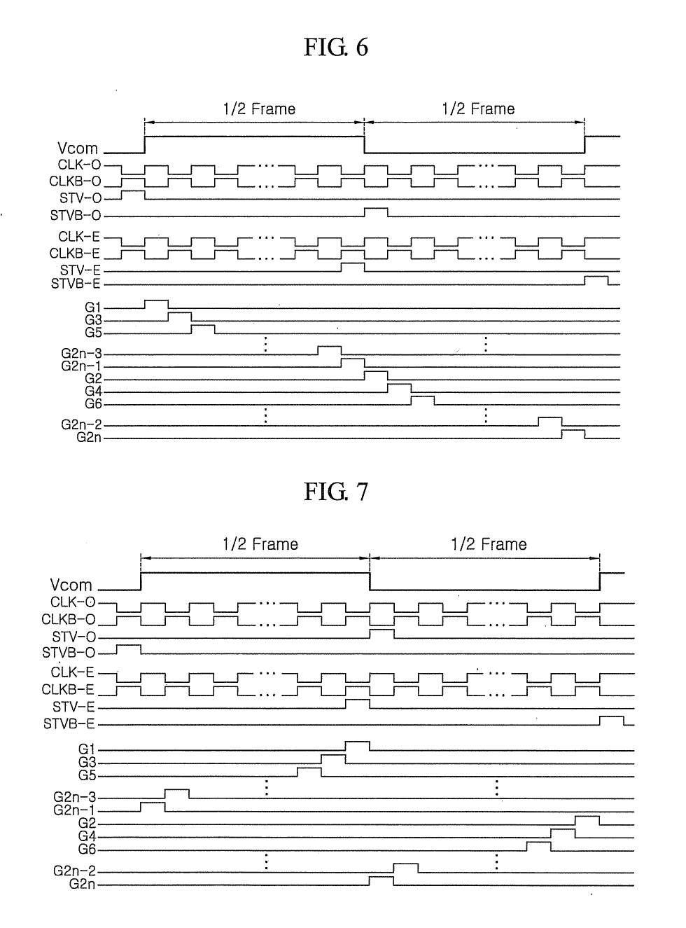

FIG. 5 is a block diagram illustrating a first exemplary embodiment of a liquid crystal panel and an exemplary embodiment of a gate driving unit, and FIG. 6 is a waveform diagram illustrating the operation of the first exemplary embodiment of an LCD device.

Referring to FIGS. 5 and 6, the first and second gate driving units 400-O and 400-E according to the first exemplary embodiment include a plurality of stages 400-1 to 400-2n connected to the gate lines G1 to G2n. As shown in FIG. 5, the first gate driving unit 400-O is provided in a left area of the liquid crystal panel 300, and the second gate driving unit 400-E is provided in a right area thereof. Alternative exemplary embodiments include configurations wherein the location of the driving units is reversed. Here, when the number of the gate lines G1 to G2n is 2n, each of the first and second gate driving units 400-O and 400-E includes n stages. The first gate driving unit 400-O includes first to (2n−1)-th stages 400-1 to 400-2n−1 connected to the odd-numbered gate lines G1 to G2n−1, and the second gate driving unit 400-E includes second to 2n-th stages 400-2 to 400-2n connected to the even-numbered gate lines G2 to G2n.

Here, the stages 400-1 to 400-2n supply the gate turn-on voltage signal Von or the gate turn-off voltage signal Voff to the gate lines G1 to G2n in response to a plurality of operation signals including clock signals CKV-O and CKV-E and inverted clock signals CKVB-O and CKVB-E, vertical sync start signals STV-O, STVB-O, STV-E, and STVB-E, and output signals SOUT1 to SOUT2 of the previous stages 400-1 to 400-2n.

In the current exemplary embodiment, the first gate driving unit 400-O is operated first and sequentially supplies the gate turn-on voltage signal Von to thin film transistors connected to the odd-numbered gate lines G1 to G2n−1, and then, the second gate driving unit 400-E sequentially supplies the gate turn-on voltage signal Von to the thin film transistors connected to the even-numbered gate lines G2 to G2n.

To this end, the signal control unit 800 first applies the first vertical sync start signal STV-O to the first stage 400-1 of the first gate driving unit 400-O. As shown in FIG. 6, when the first vertical sync start signal STV-O changes from a logic high state to a logic low state, the first stage 400-1 is driven and the common voltage signal Vcom is changed to the first voltage level (e.g., logic high state). Then, the first stage 400-1 applies the gate turn-on voltage signal Von to the first gate line G1 connected thereto. The gate turn-on voltage signal Von applied to the first gate line G1 turns on a plurality of thin film transistors connected to the first gate line G1, and the data voltage signal on the data lines D1 to Dm connected to the respective thin film transistors is charged in the respective pixel electrodes. The first stage 400-1 applies the first output signal SOUT1 to the third stage 400-3. The third stage 400-3 is driving in response to the first output signal SOUT1. The third stage 400-3 applies the gate turn-on voltage signal Von to the third gate line G3 connected thereto. The gate turn-on voltage signal Von applied to the third gate line G3 turns on a plurality of thin film transistors connected to the third gate line G3. In this manner, the pixel capacitor connected to the thin film transistor is charged. The third stage 400-3 supplies the third output signal SOUT3 to the fifth stage. In this exemplary embodiment the third stage 400-3 also supplies the third output signal SOUT3 to the first stage 400-1 to reset the first stage 400-1.

This operation continuously proceeds as described above and the (2n−3)-th output signal SOUT2n−3 is supplied to the (2n−1)-th stage 400-2n−1 to drive the (2n−1)-th stage 400-2n−1. The driven (2n−1)-th stage 400-2n−1 applies the gate turn-on voltage signal Von to the (2n−1)-th gate line G2n−1 connected thereto to turn on a plurality of thin film transistors connected to the (2n−1)-th gate line G2n−1. In the current exemplary embodiment, the (2n−1)-th stage 400-2n−1 is reset by the (1-1)-th vertical sync start signal STVB-O.

In this manner, the stages 400-1 to 400-2n−1 in the first gate driving unit 400-O are sequentially driven and the gate turn-on voltage signal Von is sequentially applied to the odd-numbered gate lines G1 to G2n−1. In the current exemplary embodiment, as shown in FIG. 6, the common voltage signal Vcom is in the logic high state while the odd numbered gate lines are driven. The application time and charging time of the signals and voltages are controlled by the clock signal CLK-O and the inverted clock signal CLKB-O. FIG. 6 shows that the gate turn-on voltage signal Von is supplied to one gate line during each half period of the clock signal CLK. Alternative exemplary embodiments include configurations wherein the gate turn-on voltage signal Von supplied to the gate line may be variously changed. In one exemplary embodiment, the gate turn-on voltage signal Von may be supplied to one gate line during one period of the clock signal. In the exemplary embodiment wherein the gate turn-on voltage signal Von is supplied to one gate line during one period of the clock signal, the periods of time of the supply of the gate turn-on voltage signals Von may overlap each other during the half period of the clock signal between one gate line and the next gate line to which the next gate turn-on voltage signal Von is supplied.

After the stages 400-1 to 400-2n−1 are driven the signal control unit 800 then applies the second vertical sync start signal STV-E to the second stage 400-2 of the second gate driving unit 400-E. As shown in FIG. 6, when the second vertical sync start signal STV-E is changed from a logic high state to a logic low state, the second stage 400-2 is driven and the common voltage signal Vcom is changed to the second voltage level (e.g., logic low state). In the current exemplary embodiment, the second vertical sync start signal STV-E is kept in the logic high state during the operation of the (2n−1)-th stage 400-2n−1 of the first gate driving unit 400-O and is then changed to a logic low state during the operation of the second through 2n-th stages of the second gate driving unit 400-E.

In response to the second vertical sync start signal STV-E, the plurality of stages 400-2 to 400-2n of the second gate driving unit 400-E perform substantially the same operations as the first gate driving unit 400-O to sequentially apply the gate turn-on voltage signal to the even-numbered gate lines G2 to G2n.

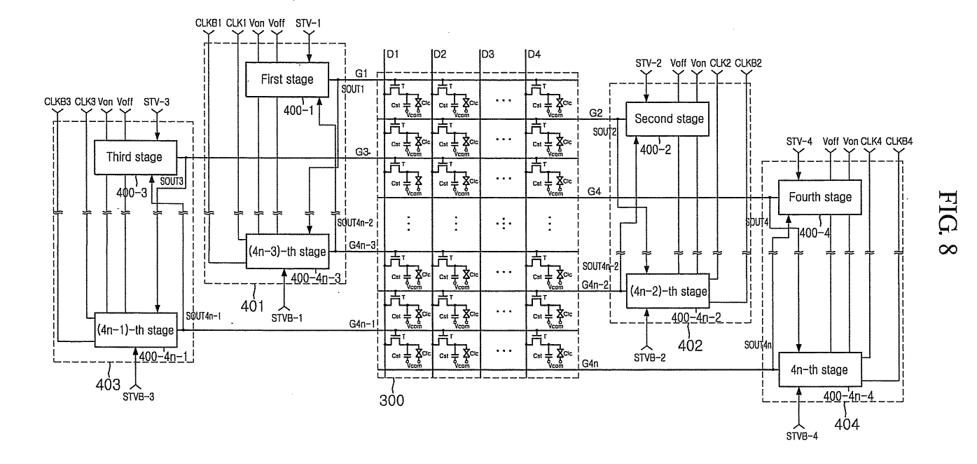

In the current exemplary embodiment, the gate turn-on voltage signal Von has been described as being applied in a direction from an upper region to a lower region of the liquid crystal panel 300. The gate turn-on voltage signal is sequentially applied to the odd-numbered gate lines in a direction from the first gate line to the lower region of the liquid crystal panel, and the gate turn-on voltage signal is sequentially applied to the even-numbered gate lines in a direction from the second gate line to the lower region. However, alternative exemplary embodiments include configurations wherein various modifications may be made thereto. One exemplary embodiment including such a variation is discussed below with reference to FIG. 7.

FIG. 7 is a waveform diagram illustrating a variation on the operation of a first exemplary embodiment of an LCD device.

Referring to FIG. 7, in this variation of the operation of the first exemplary embodiment of a liquid crystal device, the gate turn-on voltage signal Von is applied in a direction from the lower region to the upper region of the liquid crystal panel 300. The gate turn-on voltage signal Von is sequentially applied to the odd-numbered gate lines G2n−3 to G1 in a direction from the (2n−1)-th gate line G2n−1 to the upper region of the liquid crystal panel 300, and then, the gate turn-on voltage signal Von is sequentially applied to the even-numbered gate lines G2n−2 to G2 in a direction from the 2n-th gate line G2n to the upper region. When the gate turn-on voltage signal Von is sequentially applied to the odd-numbered gate lines G1 to G2n−1, the common voltage signal Vcom+ at the first voltage level is supplied to the liquid crystal panel 300. When the gate turn-on voltage signal Von is sequentially applied to the even-numbered gate lines G2 to G2n, the common voltage signal Vcom− at the second voltage level is supplied to the liquid crystal panel 300.

The (1-1)-th vertical sync start signal STVB-O is applied to the (2n−1)-th stage 400-2n−1 of the first gate driving unit 400-O, and the (2n−1)-th output signal SOUT2n−1 of the (2n−1)-th stage 400-2n−1 is applied to the (2n−3)-th stage, similar to the previous variation of the current exemplary embodiment. Further, the (2-1)-th vertical sync start signal STVB-E is applied to the 2n-th stage 400-2n of the second gate driving unit 400-E, and the 2n-th output signal SOUT2n of the 2n-th stage 400-2n is applied to the (2n−2)-th stage, again, similar to the previous variation of the current exemplary embodiment.

Through this configuration, when the (1-1)-th vertical sync start signal STVB-O changes from a logic high state to a logic low state, the voltage level of the common voltage signal Vcom is changed and the (2n−1)-th stage 400-2n−1 is operated, as shown in FIG. 7. The (2n−1)-th stage 400-2n−1 applies the gate turn-on voltage signal Von to the (2n−1)-th gate line G2n−1. The (2n−3)-th to first stages 400-2n−3 to 400-1 are then operated to sequentially supply the gate turn-on voltage signal Von to the (2n−3)-th to first gate lines G2n−3 to G1. Then, when the (2-1)-th vertical sync start signal STVB-E changes from a logic high state to a logic low state, the voltage level of the common voltage signal Vcom is changed and the 2n-th stage 400-2n is operated. The 2n-th stage 400-2n applies the gate turn-on voltage signal Von to the 2n-th gate line G2n. The (2n−2)-th to second stages 400-2n−2 to 400-2 are then operated to sequentially supply the gate turn-on voltage signal Von to the (2n−2)-th to second gate lines G2n−2 to G2.

The present invention is not limited thereto. In the exemplary embodiment of an LCD device according to this embodiment, the gate turn-on voltage signal Von may be sequentially applied in a direction toward the lower region or upper region of the liquid crystal panel 300 in response to a selection signal from the signal control unit 800. For example, the gate turn-on voltage signal Von is sequentially applied during one frame from the gate lines in the upper region of the liquid crystal panel 300 to the gate lines in the lower region, and from the gate lines in the lower region to the gate lines in the upper region for another frame. Further, in each of the gate driving units 400-O and 400-E, an application direction of the gate turn-on voltage signal Von may be changed individually. For example, the first gate driving unit 400-O may sequentially apply the gate turn-on voltage signal Von from the first gate line Gn in the upper region of the liquid crystal panel 300 to the (2n−1)-th gate line G2n−1, and the second gate driving unit 400-E may sequentially apply the gate turn-on voltage signal Von from the 2n-th gate line G2n in the lower region of the liquid crystal panel 300 to the second gate line G2. In the above, the first and second gate driving units 400-O and 400-E are sequentially operated by the first and second vertical sync start signals STV-O and STV-E and the (1-1)-th and (2-1)-th vertical sync start signals STVB-O and STVB-E from the signal control unit 800. However, the present invention is not limited thereto. In another exemplary embodiment the first gate driving unit 400-O is operated by one vertical sync start signal STV, and the second gate driving unit 400-E is operated as the output signal of the last stage in the first gate driving unit 400-O is supplied to the first stage in the second gate driving unit 400-E.

In the foregoing, the two gate driving units are disposed at both sides of the liquid crystal panel, respectively, and sequentially operated to supply the gate turn-on voltage signal to the odd-numbered gate lines when the common voltage signal is at the first voltage level and to supply the gate turn-on voltage signal to the even-numbered gate lines when the common voltage signal is at the second voltage level. However, the present invention is not limited to the above exemplary embodiment, and alternative exemplary embodiments may include two or more gate driving units and the voltage level of the common voltage signal may be changed two or more times during one frame. In consideration of the size of the liquid crystal display device and convenience in driving the device, alternative exemplary embodiments include configurations wherein the gate driving units number from 2 to 20 and the voltage level of the common voltage signal changes one to twenty times during one frame.

Another exemplary embodiment of the liquid crystal display device having a plurality of gate driving units according to the present invention will be described below. Elements which are substantially similar to those discussed in the previous exemplary embodiment will be omitted from the following description.

FIG. 8 is a block diagram illustrating a second exemplary embodiment of an LCD and a gate driving unit according to the present invention.

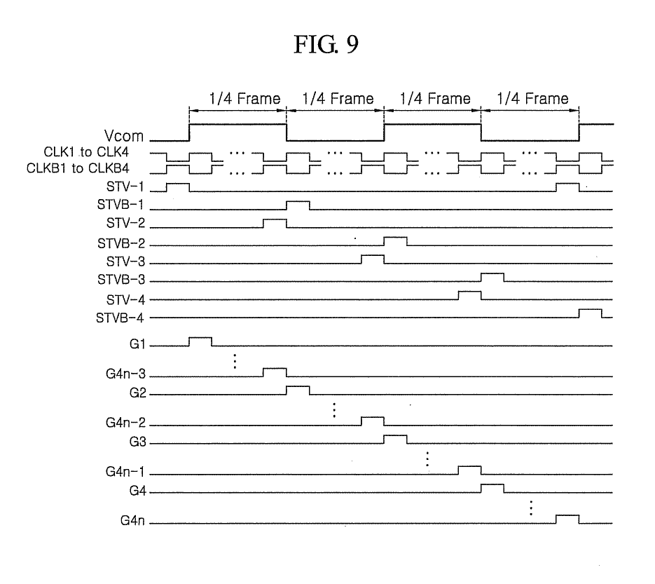

FIG. 9 is a waveform diagram illustrating the operation of the second exemplary embodiment of an LCD.

Referring to FIGS. 8 and 9, the liquid crystal display device according to this exemplary embodiment includes first to fourth gate driving units 401, 402, 403 and 404 which sequentially supply the gate turn-on voltage signal Von to gate lines G1 to G4n connected thereto in response to a control signal from the signal control unit 800.

The first gate driving unit 401 includes first to (4n−3)-th stages 400-1 to 400-4n−3 which are connected to the first to (4n−3)-th gate lines G1 to G4n−3 and are sequentially operated in response to the first and (1-1)-th vertical sync start signals STV-1 and STVB-1. The second gate driving unit 402 includes second to (4n−2)-th stages 400-2 to 400-4n−2 which are connected to the second to (4n−2)-th gate lines G2 to G4n−2 and are sequentially operated in response to the second and (2-1)-th vertical sync start signals STV-2 and STVB-2. The third gate driving unit 403 includes third to (4n−1)-th stages 400-3 to 400-4n−1 which are connected to third to (4n−1)-th gate lines G3 to G4n−1 and are sequentially operated in response to third and (3-1)-th vertical sync start signals STV-3 and STVB-3. The fourth gate driving unit 404 includes fourth to 4n-th stages 400-4 to 400-4n which are connected to fourth to 4n-th gate lines G4 to G4n and are sequentially operated in response to fourth and (4-1)-th vertical sync start signal STV-4 and STVB-4.

In the present exemplary embodiment, the plurality of gate lines G1 to G4n of the liquid crystal panel 300 are connected to the first to fourth gate driving units 401, 402, 403 and 404 in a predetermined order. As shown in FIG. 8, a gate line below the gate line connected to the first gate driving unit 401 is connected to the second gate driving unit 402. A gate line below the gate line connected to the second gate driving unit 402 is connected to the third gate driving unit 403. A gate line below the gate line connected to the third gate driving unit 403 is connected to the fourth gate driving unit 404. A gate line below the gate line connected to the fourth gate driving unit 404 is connected to the first gate driving unit 401, and so forth until all of the gate lines are connected to the various gate driving units.

In this exemplary embodiment, the first to fourth gate driving units 401, 402, 403 and 404 are sequentially operated, and the voltage level of the common voltage signal Vcom supplied to the liquid crystal panel 300 changes whenever the operation of the first to fourth gate driving units changes.

As shown in FIG. 9, the first gate driving unit 401 sequentially applies the gate turn-on voltage signal Von to the plurality of gate lines G1 to G4n−3 connected thereto in response to the first vertical sync start signal STV-1 from the signal control unit 800. When the first vertical sync start signal STV-1 changes from a logic high state to a logic low state, the first stage 400-1 of the first gate driving unit 401 applies the gate turn-on signal Von to the first gate line G1. Then, the stages in the first gate driving unit 401 are sequentially driven in response to the output signal SOUT1 of the previous stage and apply the gate turn-on signal to the gate lines connected thereto. The previous stage is reset by the output signal of the subsequent stage.

The (4n−3)-th stage 400-4n−3 which is the last stage of the first gate driving unit 401 supplies the gate turn-on signal Von to the (4n−3)-th gate line G4n−3. Accordingly, the first gate driving unit 401 stops its operation and the signal control unit 800 supplies the second vertical sync start signal STV-2 to the second gate driving unit 402. The (1-1)-th vertical sync start signal STVB-1 is then supplied to the (4n−3)-th stage 400-4n−3 to reset the (4n−3)-th stage 400-4n−3.

In response to the second vertical sync start signal STV-2, the second to (4n−2)-th stages 400-2 to 400-4n−2 in the second gate driving unit 402 are sequentially operated to apply the gate turn-on voltage signal Von to a plurality of gate lines G2 to G4n−2 connected thereto. After the gate turn-on voltage signal Von is completely applied to the plurality of gate lines G2 to G4n−2 which are connected to the second gate driving unit 402, the second gate driving unit 402 stops its operation and the signal control unit 800 supplies the third vertical sync start signal STV-3 to the third gate driving unit 403. In response to the third vertical sync start signal STV-3, the third to (4n−1)-th stages 400-3 to 400-4n−1 in the third gate driving unit 403 are sequentially operated to apply the gate turn-on voltage signal Von to a plurality of gate lines G3 to G4n−1 connected thereto. After the gate turn-on voltage signal Von is applied, the third gate driving unit 403 stops its operation and the fourth vertical sync start signal SVT-4 is supplied to the fourth gate driving unit 404. In response to the fourth vertical sync start signal SVT-4, the fourth gate driving unit 404 sequentially drives the fourth to 4n-th stages 400-4 to 400-4n therein to apply the gate turn-on voltage signal Von to a plurality of gate lines G4 to G4n connected thereto. In this manner, the gate turn-on voltage signal Von can be supplied to all of the gate lines G1 to G4n in the liquid crystal panel 300.

As shown in FIG. 9, when the first gate driving unit 401 is operating, the common voltage signal Vcom is kept at a voltage level in a logic high state. When the second gate driving unit 402 is operating, the common voltage signal Vcom is kept at a voltage level in a logic low state. When the third gate driving unit 403 is operating, the common voltage signal Vcom is kept at a voltage level in a logic high state. When the fourth gate driving unit 404 is operating, the common voltage signal Vcom is kept at a voltage level in a logic low state. In this manner, according to the present exemplary embodiment, the logic state of the common voltage signal Vcom changes four times during one frame. The common voltage signal Vcom having a period corresponding to a ½ frame can be supplied to the liquid crystal panel 300. This can prevent increase in power consumption due to the change in the voltage level of the common voltage signal Vcom, and can reduce or effectively prevent generation of audible noise.

Further, the common voltage signal Vcom in a logic high state is applied to the first and third gate driving units 401 and 403 and the common voltage signal Vcom in a logic low state is applied to the second and fourth gate driving units 402 and 404, so that the liquid crystal display device performs line inversion, similar to the previous exemplary embodiment. Pixels connected to the odd-numbered gate lines have a positive signal polarity by means of the first and third gate driving units 401 and 403, and pixels connected to the even-numbered gate lines have a negative signal polarity by means of the second and fourth gate driving units 402 and 404.

As described above, according to the present invention, power consumption of the display device can be reduced by minimizing a change in the voltage level of the common voltage signal supplied to the display panel during one frame.

Further, the gate driving unit connected to the odd-numbered gate lines and the gate driving unit connected to the even-numbered gate lines are sequentially operated, and the voltage level of the common voltage signal is changed when the operation of the gate driving units is changed, so that the number of changes in the common voltage signal can be minimized and the pixels of the liquid crystal panel can be subjected to line inversion driving.

In addition, the plurality of gate driving units can be sequentially operated by sequentially supplying the vertical sync start signal from the signal control unit to the gate driving unit.

Although the present invention has been described in connection with the accompanying drawings and the exemplary embodiments, the present invention is not limited thereto but defined by the appended claims. Accordingly, it will be understood by those skilled in the art that various modifications and changes can be made thereto without departing from the spirit and scope of the present invention defined by the appended claims.

What is claimed is:

1. A method of driving a display device, comprising:
sequentially supplying a gate voltage signal to a first group of gate lines of a plurality of gate lines; and
sequentially supplying a gate voltage signal to a second group of gate lines of the plurality of gate lines which differ from the first group of gate lines,
wherein a common voltage signal in the first step and a common voltage signal in the second step have different logic voltage levels, respectively.

2. The method as claimed in claim 1, wherein a data voltage signal and the common voltage signal have different logic voltage levels, respectively.

3. The method as claimed in claim 1, wherein the gate lines in the first group of gate lines are odd-numbered gate lines, and the gate lines in the second group of gate lines are even-numbered gate lines.

4. The method as claimed in claim 1, wherein a first gate driving unit is provided in one area of the display device to supply the gate voltage signals to the first group of gate lines, and a second gate driving unit is provided in another area of the display device to supply the gate voltage signals to the second group of gate lines.

5. A method of driving a display device, comprising:
dividing a plurality of gate lines into a plurality of groups of gate lines, wherein each of the groups of gate lines is one of an odd numbered group of gate lines and an even numbered group of gate lines, and each of the groups of gate lines includes at least two gate lines; and
sequentially driving the groups of gate lines in a predetermined order during one frame,
wherein a common voltage signal with a first logic voltage level is applied when an odd numbered group of gate lines is driven, and a common voltage signal with a second logic voltage level is applied when an even numbered group of gate lines is driven.

6. The method as claimed in claim 5, wherein a data voltage signal and the common voltage signal have different logic voltage levels, respectively.

7. A display device comprising:
a first group of gate lines; and
a second group of gate lines,
wherein a gate voltage is sequentially supplied to the gate lines in the first group of gate lines and then supplied to the gate lines in the second group of gate lines and wherein a common voltage signal with a first logic voltage level is applied when the first group of gate lines is driven and a common voltage signal with a second logic voltage level is applied when the second group of gate lines is driven.
